(19) United States
(12) Patent Application Publication
(10) Pub. No.: US 2023/0412453 A1
(43) Pub. Date: Dec. 21, 2023

(54) RADIO SYSTEM MAINTENANCE SUPPORT DEVICE, RADIO SYSTEM MAINTENANCE SUPPORT METHOD, AND RADIO SYSTEM MAINTENANCE SUPPORT PROGRAM

(71) Applicant: NIPPON TELEGRAPH AND TELEPHONE CORPORATION, Tokyo (JP)

(72) Inventors: Hitoshi HASEGAWA, Musashino-shi, Tokyo (JP); Toshifumi MIYAGI, Musashino-shi, Tokyo (JP); Hayato FUKUZONO, Musashino-shi, Tokyo (JP); Hiroyuki FURUYA, Musashino-shi, Tokyo (JP)

(73) Assignee: NIPPON TELEGRAPH AND TELEPHONE CORPORATION, Tokyo (JP)

(21) Appl. No.: 18/273,553

(22) PCT Filed: Feb. 1, 2021
(86) PCT No.: PCT/JP2021/003586

§ 371 Date: Jul. 21, 2023

(51) Int. Cl. H04L 41/0677; H04B 17/17

(52) U.S. Cl. CPC H04L 41/0677; H04B 17/17

(57) ABSTRACT

A radio system maintenance support device supports maintenance of radio system. System status information indicates at least one of radio communication status and device status of radio device in the radio system. Anomaly situation information indicates anomaly situation in the radio system. Failure analysis result information indicates at least one of failure location in the radio system and maintenance action required for the failure location. A failure analysis model is a trained model receiving at least the anomaly situation information and outputting the failure analysis result information, which is generated by learning based on past anomaly situation information and past failure analysis result information. The radio system maintenance support device analyzes the system status information to acquire the anomaly situation information. The radio system maintenance support device further acquires the failure analysis result information according to the anomaly situation information by using the failure analysis model.

### TECHNICAL FIELD

The present invention relates to a technology for supporting maintenance of a radio system.

### BACKGROUND ART

In conventional maintenance of a radio system, a maintenance engineer collects a variety of information including a reception level, a waveform, an alarm from a radio device, and the like, estimates a failure location based on the collected information, and determines a maintenance action. Such the maintenance method greatly depends on individual knowhow and empirical rules, and thus requires a highly skilled maintenance engineer having years of experience.

NPL 1 discloses a technology for estimating a fault location in a carrier network based on rules.

### CITATION LIST

### Non Patent Literature

[NPL 1] K. Itoi, H. Oishi, and K. Okazaki, “Automatic Fault Locating Technology on the Carrier Network”, 2016 IEICE Communication Society Symposium, B-14-12, September 2016

### Technical Problem

### SUMMARY OF INVENTION

A conventional maintenance method for a radio system greatly depends on individual knowhow and empirical rules, and thus requires a highly skilled maintenance engineer having years of experience. If such high-level maintenance engineers decrease due to retirement or the like, efficiency and accuracy of the maintenance of the radio system may decrease.

An object of the present invention is to provide a technique capable of efficiently performing maintenance of a radio system without relying on skill and experience of individual maintenance engineers.

### Solution to Problem

A first aspect provides a radio system maintenance support device for supporting maintenance of a radio system.

The radio system maintenance device includes:
one or more processors; and
one or more storage devices in which system status information, anomaly situation information, failure analysis result information, and a failure analysis model are stored.

The system status information indicates at least one of a radio communication status in the radio system and a device status of a radio device included in the radio system.

The anomaly situation information indicates a situation of anomaly in the radio system.

The failure analysis result information indicates at least one of a failure location in the radio system and a maintenance action required for the failure location.

The failure analysis model is a trained model that receives at least the anomaly situation information and outputs the failure analysis result information, which is generated by learning based on the anomaly situation information and the failure analysis result information that are obtained in the past.

The one or more processors are configured to:
acquire the system status information;
analyze the system status information to acquire the anomaly situation information;
acquire the failure analysis result information according to the anomaly situation information by using the failure analysis model; and
present the acquired failure analysis result information to a maintenance engineer.

A second aspect provides a radio system maintenance support method for supporting maintenance of a radio system.

The radio system maintenance support method includes:
acquiring system status information indicating at least one of a radio communication status in the radio system and a device status of a radio device included in the radio system; and
analyzing the system status information to acquire anomaly situation information indicating a situation of anomaly in the radio system.

Failure analysis result information indicates at least one of a failure location in the radio system and a maintenance action required for the failure location.

A failure analysis model is a trained model that receives at least the anomaly situation information and outputs the failure analysis result information, which is generated by learning based on the anomaly situation information and the failure analysis result information that are obtained in the past.

The radio system maintenance support method further includes:
acquiring the failure analysis result information according to the anomaly situation information by using the failure analysis model; and
presenting the acquired failure analysis result information to a maintenance engineer.

A third aspect provides a radio system maintenance support program. The radio system maintenance support program, when executed by a computer, causes the computer to executed the radio system maintenance support method stated described above. The radio system maintenance support program may be recorded on a non-transitory computer-readable recording medium. The radio system maintenance support program may be provided via a network.

### Advantageous Effects of Invention

According to the present invention, the failure analysis model is generated based on information on past maintenance records. Using the failure analysis model makes it possible to automatically acquire appropriate failure analysis result information according to a present situation. The acquired failure analysis result information is presented to a maintenance engineer. The maintenance engineer is able to perform a proper maintenance action by referring to the failure analysis result information. It is thus possible to efficiently perform the maintenance of the radio system without relying on skill and experience of individual maintenance engineers.

### BRIEF DESCRIPTION OF DRAWINGS

FIG. 1 is a schematic diagram for explaining an overviews of a radio system and a radio system maintenance support device according to an embodiment of the present invention.

FIG. 2 is a block diagram showing an exemplified configuration of a radio system maintenance support device according to an embodiment of the present invention.

FIG. 3 is a block diagram showing a variety of information used in a radio system maintenance support device according to an embodiment of the present invention.

FIG. 4 is a block diagram showing an example of system status information according to an embodiment of the present invention.

FIG. 5 is a schematic diagram showing various examples of anomaly situation information according to an embodiment of the present invention.

FIG. 6 is a block diagram conceptually showing a first example of a failure analysis model according to an embodiment of the present invention.

FIG. 7 is a block diagram conceptually showing a second example of a failure analysis model according to an embodiment of the present invention.

FIG. 8 is a block diagram showing a functional configuration related to failure analysis processing executed by a radio system maintenance support device according to an embodiment of the present invention.

FIG. 9 is a flowchart showing failure analysis processing according to an embodiment of the present invention.

### DESCRIPTION OF EMBODIMENTS

Embodiments of the present invention will be described below with reference to the accompanying drawings.

### 1. Configuration

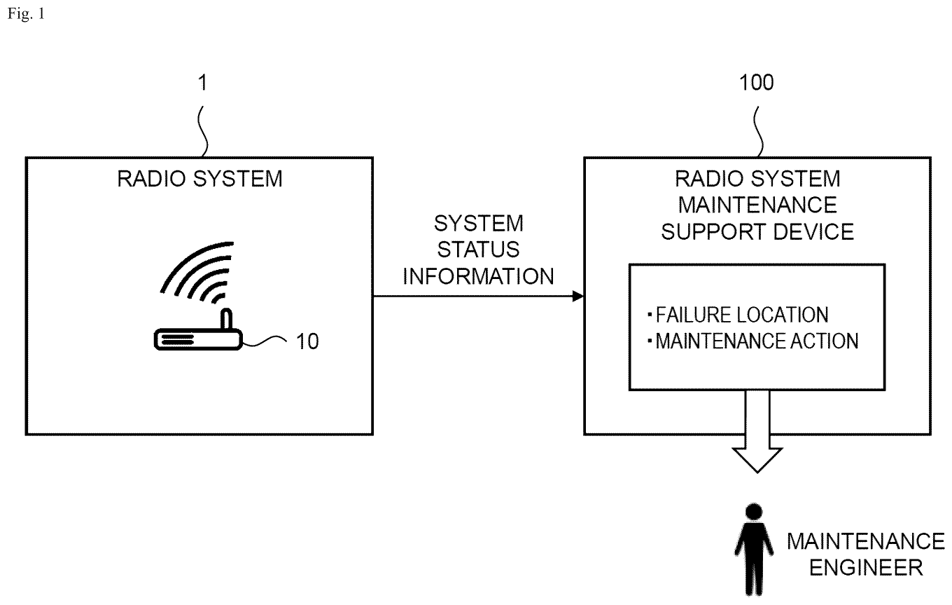

FIG. 1 is a schematic diagram for explaining an overview of a radio system 1 and a radio system maintenance support device 100 according to the present embodiment. The radio system 1 includes one or more radio devices 10 performing radio communication. Examples of the radio device 10 include a radio terminal, a base station, an access point, and the like.

The radio system maintenance support device 100 supports maintenance of the radio system 1. Specifically, the radio system maintenance support device 100 acquires system status information indicating a status of the radio system 1. Further, the radio system maintenance support device 100 automatically estimates a failure location in the radio system 1 based on the system status information, and automatically determines a maintenance action required for repairing the failure location. The radio system maintenance support device 100 presents the failure location and/or the maintenance action to a maintenance engineer. The maintenance engineer is able to efficiently perform the maintenance of the radio system 1 by referring to the information presented from the radio system maintenance support device 100.

The radio system maintenance support device 100 is a computer. For example, the radio system maintenance support device 100 is a general-purpose computer such as a personal computer. Alternatively, the radio system maintenance support device 100 may be a computer dedicated to the maintenance of the radio system.

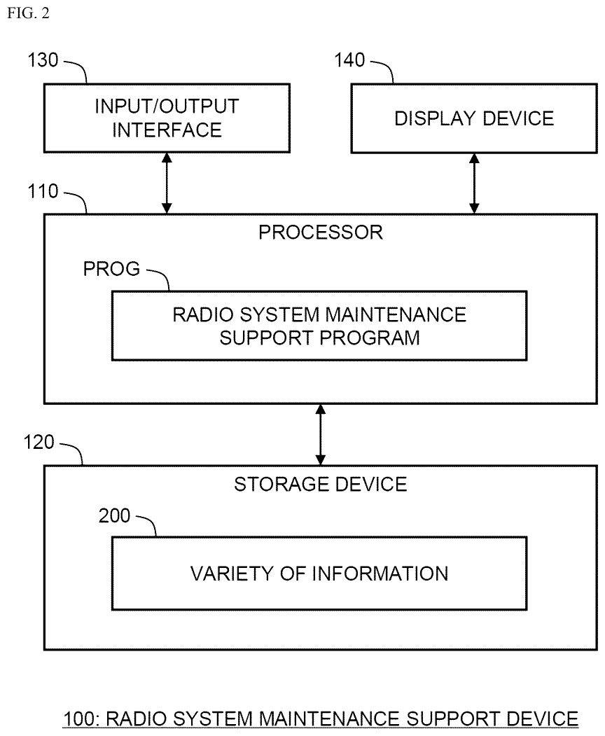

FIG. 2 is a block diagram showing an exemplified configuration of the radio system maintenance support device 100 according to the present embodiment. The radio system maintenance support device 100 includes one or more processors 110 (hereinafter simply referred to as a “processor 110”), one or more storage devices 120 (hereinafter simply referred to as a “storage device 120”), an input/output interface 130, and a display device 140.

The processor 110 executes a variety of information processing. In particular, the processor 110 executes “failure analysis processing” which will be described later. For example, the processor 110 includes a central processing unit (CPU).

The storage device 120 stores a variety of information 200 necessary for the processing executed by the processor 110. Examples of the storage device 120 include a volatile memory, a non-volatile memory, a hard disk drive (HDD), a solid state drive (SSD), and the like.

The input/output interface 130 is an interface for communicating with the outside of the radio system maintenance support device 100. Examples of the input/output interface 130 include a communication interface, a Universal Serial Bus (USB) interface, a user interface, and the like.

The display device 140 displays a variety of of information. Examples of the display device 140 include a liquid crystal display and the like.

A radio system maintenance support program PROG is a computer program executed by the processor 110. Functions of the radio system maintenance support device 100 are implemented by the processor 110 executing the radio system maintenance support program PROG. The radio system maintenance support program PROG is stored in the storage device 120. The radio system maintenance support program PROG may be recorded on a non-transitory computer-readable recording medium. The radio system maintenance support program PROG may be provided via a network to the radio system maintenance support device 100. In any case, the radio system maintenance support program PROG is executed by the processor 110 to implement the functions of the radio system maintenance support device 100.

### 2. Explanation of Variety of Information

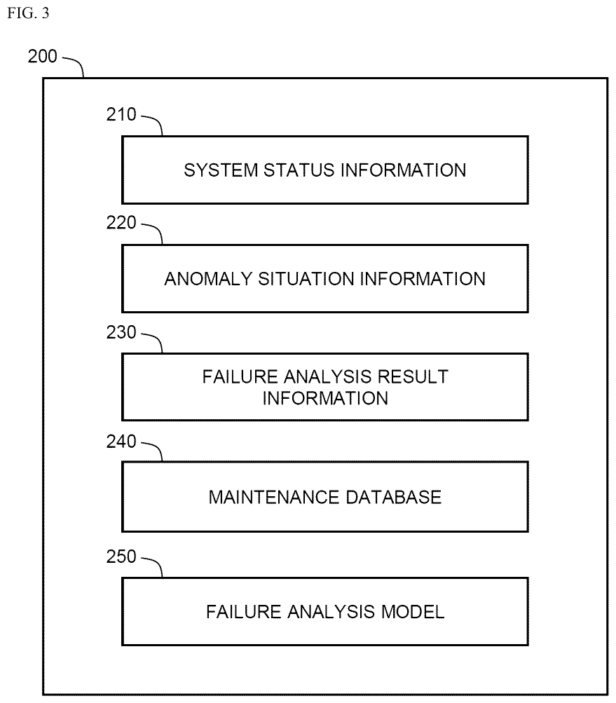

FIG. 3 is a block diagram showing the variety of information 200 used in the radio system maintenance support device 100 according to the present embodiment. The variety of information 200 includes system status information 210, anomaly situation information 220, failure analysis result information 230, a maintenance database 240, and a failure analysis model 250.

### 2-1. System Status Information

The system status information 210 is information indicating a status of the radio system 1. More specifically, the system status information 210 indicates at least one of a radio communication status in the radio system 1 and a device status of each radio device 10. The system status information 210 is acquired from the radio system 1.

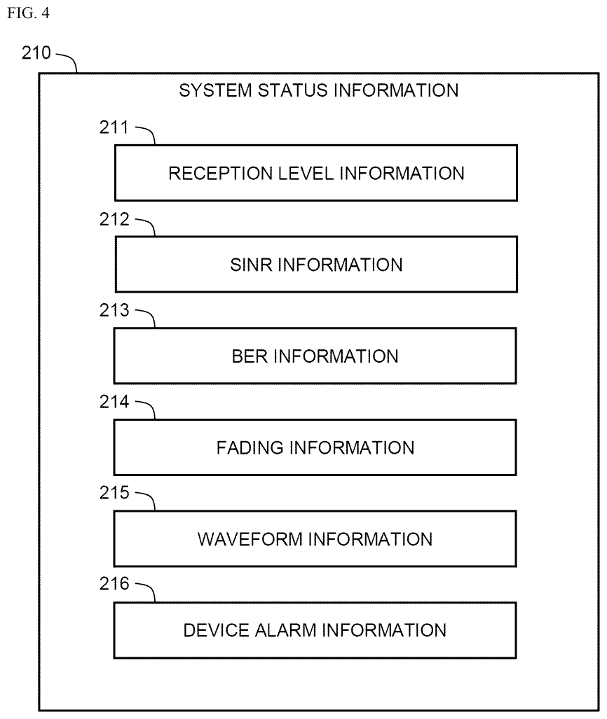

FIG. 4 is a block diagram showing an example of the system status information 210. In the example shown in FIG. 4, the system status information 210 includes reception level information 211, SINR information 212, BER information 213, fading information 214, waveform information 215, and device alarm information 216.

The reception level information 211 indicates a reception level (received power) of a radio wave in the radio device 10. The reception level information 211 is acquired from the radio device 10.

The SINR information 212 indicates a signal-to-interference-noise ratio (SINR) of a received signal in the radio device 10. The SINR information 212 is acquired from the radio device 10.

The BER information 213 includes a bit error rate (BER) of a received signal in the radio device 10. The BER information 213 is acquired from the radio device 10.

The fading information 214 indicates fading which is a variation in the reception level in the radio device 10. The fading information 214 is acquired from the radio device 10.

The waveform information 215 indicates a waveform of the reception signal in the radio device 10. The waveform information 215 is acquired from a spectrum analyzer.

The device alarm information 216 indicates an alarm output from the radio device 10 in a case where an anomaly occurs in the radio device 10. The device alarm information 216 is acquired from the radio device 10.

It should be noted that it is not always necessary for the system status information 210 to include all the information exemplified in FIG. 4. The system status information 210 includes at least one of the reception level information 211, the SINR information 212, the BER information 213, the fading information 214, the waveform information 215, and the device alarm information 216.

### 2-2. Anomaly Situation Information

The anomaly situation information 220 indicates a situation of anomaly (fault) in the radio system 1. The anomaly situation information 220 is acquired by analyzing the system status information 210 described above.

For example, in a case where the reception level indicated by the reception level information 211 is less than a predetermined reception level threshold, it is determined that the reception level is abnormal. As another example, in a case where the SINR indicated by the SINR information 212 is less than a predetermined SINR threshold, it is determined that the SINR is abnormal. As still another example, in a case where the BER indicated by the BER information 213 is equal to or greater than a predetermined BER threshold, it is determined that the BER is abnormal. As still another example, in a case where a fading level indicated by the fading information 214 is equal to or greater than a certain level, it is determined that abnormal fading occurs. As still another example, comparing the waveform indicated by the waveform information 215 with an ideal waveform makes it possible to determine whether or not the waveform is distorted. In a case where the waveform indicated by the waveform information 215 has “distortion”, it is determined that the waveform is abnormal.

The device alarm information 216 itself indicates that an anomaly occurs in the radio device 10. It should be noted that various types of anomalies can occur in the radio device 10. Examples of the anomaly in the radio device 10 include anomaly of an antenna, anomaly of a processor, and the like.

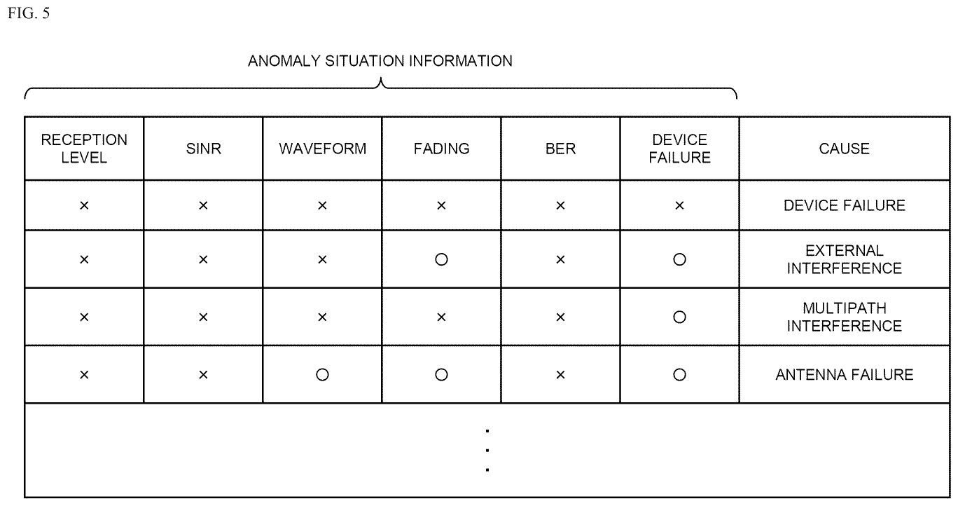

FIG. 5 shows various examples of the anomaly situation information 220. The anomaly situation information 220 indicates presence or absence of the anomaly for each parameter (reception level, SINR, waveform, and the like) indicated by the system status information 210. In the example shown in FIG. 5, a circle represents “normal”, and a cross represents “abnormal.” It can be said that the anomaly situation information 220 indicates a combination of presences/absences of anomalies regarding a plurality of parameters.

As shown in FIG. 5, there are various combination patterns of presences/absences of anomalies regarding a plurality of parameters. In reality, there are numerous possible combination patterns. Therefore, if it is necessary for a maintenance engineer to estimate a failure cause and a failure location from a certain combination pattern, special knowhow and rich experience are required, and the maintenance engineer has enormous burden. How to solve such a problem will be described later.

### 2-3. Failure Analysis Result Information

The failure analysis result information 230 is information indicating at least one of a failure location in the radio system 1 and a maintenance action required for the failure location. The failure analysis result information 230 may indicate both the failure location and the maintenance action required for the failure location.

For example, a maintenance engineer who has advanced skill and long-term experience identifies a failure location by a try and error base on the anomaly situation information 220, and determines a maintenance action. However, in this case, the maintenance engineer bears enormous burden, and thus it is not always efficient.

As will be described later, according to the present embodiment, the failure analysis result information 230 can be also automatically acquired by the radio system maintenance support device 100.

### 2-4. Maintenance Database

The maintenance database 240 is a database storing past maintenance records for the radio system 1. More specifically, the maintenance database 240 indicates a correspondence relationship between the system status information 210, the anomaly situation information 220, and the failure analysis result information 230 that are acquired in the past. For example, the maintenance engineer performs the maintenance of the radio system 1 to acquire the failure analysis result information 230. The system status information 210, the anomaly situation information 220, and the failure analysis result information 230 at that time are associated with each other and stored in the maintenance database 240. Each time the maintenance engineer performs the maintenance, the maintenance database 240 is updated.

As will be described later, in some cases, the failure analysis result information 230 is automatically acquired by the radio system maintenance support device 100. In this case, the system status information 210, the anomaly situation information 220, and the failure analysis result information 230 may be added to the maintenance database 240. That is, the maintenance database 240 may be updated appropriately based on information automatically acquired by the radio system maintenance support device 100.

### 2-5. Failure Analysis Model

The failure analysis model 250 is a model that automatically generates and outputs the failure analysis result information 230 based on predetermined input information. The failure analysis model 250 is a trained model generated by learning such as deep learning. Learning of the failure analysis model 250 is performed by utilizing the maintenance database 240 described above.

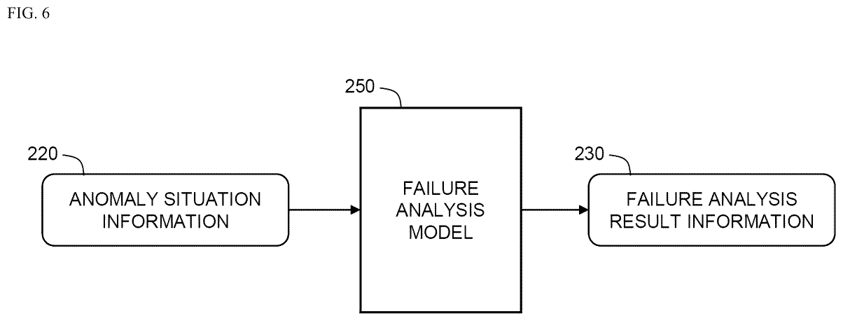

FIG. 6 is a block diagram conceptually showing a first example of the failure analysis model 250. In the first example, the input information input to the failure analysis model 250 is the anomaly situation information 220 described above. That is, the failure analysis model 250 receives the anomaly situation information 220 and outputs the failure analysis result information 230. Such the failure analysis model 250 is generated through learning based on past anomaly situation information 220 and past failure analysis result information 230 stored in the maintenance database 240.

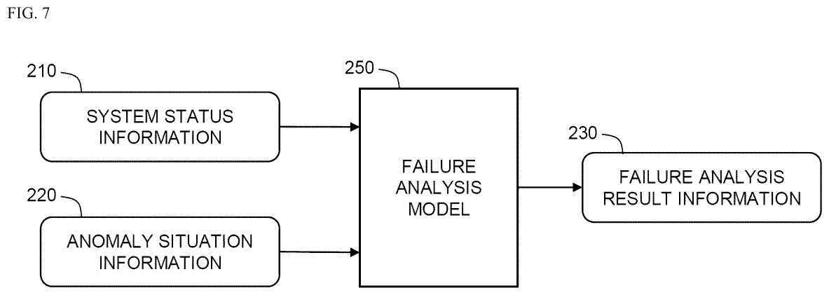

FIG. 7 is a block diagram conceptually showing a second example of the failure analysis model 250. In the second example, the input information input to the failure analysis model 250 includes the system status information 210 and the anomaly situation information 220 described above. That is, the failure analysis model 250 receives the system status information 210 and the anomaly situation information 220, and outputs the failure analysis result information 230. Such the failure analysis model 250 is generated through learning based on past system status information 210, past anomaly situation information 220, and past failure analysis result information 230 stored in the maintenance database 240.

### 3. Failure Analysis Processing

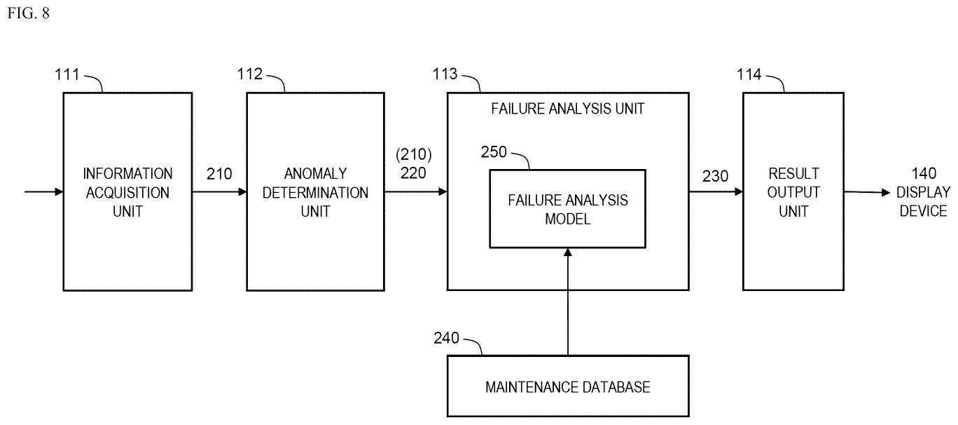

FIG. 8 is a block diagram showing a functional configuration related to failure analysis processing executed by the radio system maintenance support device 100 (the processor 110) according to the present embodiment. The processor 110 includes, as functional blocks, an information acquisition unit 111, an anomaly determination unit 112, a failure analysis unit 113, and a result output unit 114. These functional blocks are implemented by the processor 110 executing the radio system maintenance support program PRO G.

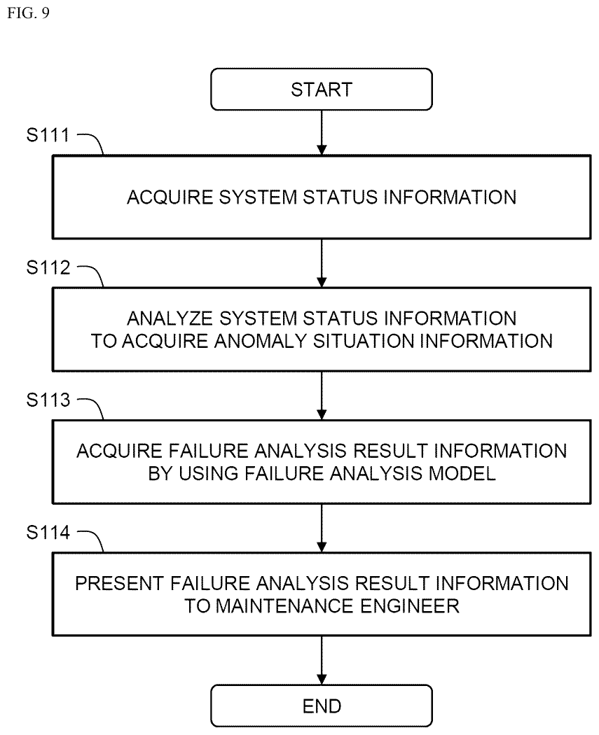

FIG. 9 is a flowchart showing the failure analysis processing according to the present embodiment.

In Step S111, the information acquisition unit 111 acquires current system status information 210 via the input/output interface 130. The current system status information 210 is stored in the storage device 120.

In Step S112, the anomaly determination unit 112 analyzes the current system status information 210 to acquire current anomaly situation information 220. The method of acquiring the anomaly situation information 220 from the system status information 210 is as described in the above Section 2-2. The current anomaly situation information 220 is stored in the storage device 120.

In Step S113, the failure analysis unit 113 automatically acquires the failure analysis result information 230 by using the failure analysis model 250. As described above, the failure analysis model 250 is generated in advance based on the maintenance database 240 and stored in the storage device 120. The failure analysis unit 113 reads out the failure analysis model 250 from the storage device 120.

In the first example of the failure analysis model 250 shown in FIG. 6, the failure analysis unit 113 automatically acquires the failure analysis result information 230 according to the current anomaly situation information 220 by using the current anomaly situation information 220 and the failure analysis model 250. The failure analysis result information 230 is stored in the storage device 120.

In the second example of the failure analysis model 250 shown in FIG. 7, the failure analysis unit 113 automatically acquires the failure analysis result information 230 according to the current system status information 210 and the current anomaly situation information 220 by using the current system status information 210, the current anomaly situation information 220, and the failure analysis model 250. The failure analysis result information 230 is stored in the storage device 120.

In Step S114, the result output unit 114 presents the acquired failure analysis result information 230 to the maintenance engineer (user). Specifically, the result output unit 114 displays the acquired failure analysis result information 230 on the display device 140. The failure analysis result information 230 indicates at least one of the failure location in the radio system 1 and the maintenance action required for the failure location. The maintenance engineer is able to perform a proper maintenance action by referring to the failure analysis result information 230.

### 4. Advantageous Effects

As described above, according to the present embodiment, the failure analysis model 250 is generated based on information on past maintenance records stored in the maintenance database 240. The radio system maintenance support device 100 is able to automatically acquire the appropriate failure analysis result information 230 according to a current situation by using the failure analysis model 250. The radio system maintenance support device 100 presents the acquired failure analysis result information 230 to the maintenance engineer (user). The maintenance engineer is able to perform a proper maintenance action by referring to the failure analysis result information 230.

Consequently, according to the present embodiment, it is possible to perform the maintenance of the radio system 1 efficiently and with high accuracy, without relying on skill and experience of individual maintenance engineers. Even if high-level maintenance engineers having advanced skill and years of experience decrease due to retirement or the like, high-quality maintenance can be maintained. Further, the number of times of try and errors in maintenance is reduced, and wasteful work is also reduced. Moreover, the time and costs required for training of maintenance engineers can be saved.

### REFERENCE SIGNS LIST

1: Radio system
10: Radio device
100: Radio system maintenance support device
110: Processor
111: Information acquisition unit
112: Anomaly determination unit
113: Failure analysis unit
114: Result output unit
120: Storage device
130: Input/output interface
140: Display device
200: Variety of information
210: System status information
220: Anomaly situation information
230: Failure analysis result information
240: Maintenance database
250: Failure analysis model
PROG: Radio system maintenance support program

1. A radio system maintenance support device for supporting maintenance of a radio system, the radio system maintenance device comprising:
one or more processors; and
one or more memories in which system status information, anomaly situation information, failure analysis result information, and a failure analysis model are stored, wherein
the system status information indicates at least one of a radio communication status in the radio system and a device status of a radio device included in the radio system,
the anomaly situation information indicates a situation of anomaly in the radio system,
the failure analysis result information indicates at least one of a failure location in the radio system and a maintenance action required for the failure location,
the failure analysis model is a trained model that receives at least the anomaly situation information and outputs the failure analysis result information, which is generated by learning based on the anomaly situation information and the failure analysis result information that are obtained in the past, and
the one or more processors are configured to:
acquire the system status information;
analyze the system status information to acquire the anomaly situation information;
acquire the failure analysis result information according to the anomaly situation information by using the failure analysis model; and
present the acquired failure analysis result information to a maintenance engineer.

2. The radio system maintenance support device according to claim 1, wherein
the failure analysis model is a trained model that receives the system status information and the anomaly situation information and outputs the failure analysis result information, which is generated by learning based on the system status information, the anomaly situation information, and the failure analysis result information that are obtained in the past, and
the one or more processors are configured to acquire the failure analysis result information according to the system status information and the anomaly situation information by using the failure analysis model.

3. The radio system maintenance support device according to claim 1, wherein
the system status information indicates at least one of a reception level, a waveform, a signal-to-interference-noise ratio, a bit error rate, fading, and an alarm output from the radio device.

4. A radio system maintenance support method for supporting maintenance of a radio system, the radio system maintenance support method comprising:
acquiring system status information indicating at least one of a radio communication status in the radio system and a device status of a radio device included in the radio system; and
analyzing the system status information to acquire anomaly situation information indicating a situation of anomaly in the radio system, wherein
failure analysis result information indicates at least one of a failure location in the radio system and a maintenance action required for the failure location,
a failure analysis model is a trained model that receives at least the anomaly situation information and outputs the failure analysis result information, which is generated by learning based on the anomaly situation information and the failure analysis result information that are obtained in the past, and
the radio system maintenance support method further comprises:
acquiring the failure analysis result information according to the anomaly situation information by using the failure analysis model; and
presenting the acquired failure analysis result information to a maintenance engineer.

5. The radio system maintenance support method according to claim 4, wherein
the failure analysis model is a trained model that receives the system status information and the anomaly situation information and outputs the failure analysis result information, which is generated by learning based on the system status information, the anomaly situation information, and the failure analysis result information that are obtained in the past, and
the acquiring the failure analysis result information includes acquiring the failure analysis result information according to the system status information and the anomaly situation information by using the failure analysis model.

6. The radio system maintenance support method according to claim 4, wherein
the system status information indicates at least one of a reception level, a waveform, a signal-to-interference-noise ratio, a bit error rate, fading, and an alarm output from the radio device.

7. (canceled)

8. A non-transitory computer-readable recording medium on which a radio system maintenance support program for supporting maintenance of a radio system is recoded, wherein
system status information indicates at least one of a radio communication status in the radio system and a device status of a radio device included in the radio system,
anomaly situation information indicates a situation of anomaly in the radio system,
failure analysis result information indicates at least one of a failure location in the radio system and a maintenance action required for the failure location,
a failure analysis model is a trained model that receives at least the anomaly situation information and outputs the failure analysis result information, which is generated by learning based on the anomaly situation information and the failure analysis result information that are obtained in the past, and
the radio system maintenance support program, when executed by a computer, causes the computer to execute:
acquiring the system status information;
analyzing the system status information to acquire the anomaly situation information;
acquiring the failure analysis result information according to the anomaly situation information by using the failure analysis model; and
presenting the acquired failure analysis result information to a maintenance engineer.
